(19) United States
(12) Patent Application Publication
(10) Pub. No.: US 2021/0047096 A1
(43) Pub. Date: Feb. 18, 2021

(54) PLASTIC FILM COMPOSITE, PLASTIC PACKAGING AND METHOD FOR PRODUCING A PLASTIC FILM COMPOSITE

(71) Applicant: Mondi AG, Wien (AT)

(72) Inventors: Uwe OBERMANN, Gronau (DE); Ulf SEIFERT, Ochtrup (DE)

(73) Assignee: Mondi AG, Wien (AT)

(21) Appl. No.: 16/964,067

(22) PCT Filed: Nov. 28, 2019
(86) PCT No.: PCT/EP2019/082842

§ 371 Date: Jul. 22, 2020

(30) Foreign Application Priority Data
Dec. 14, 2018 (DE) 10 2018 132 343.3

(51) Int. Cl. B65D 65/40; B32B 27/32; B32B 27/08; B32B 7/12; B32B 1/00; B32B 37/15

(52) U.S. Cl. CPC B65D 65/40; B32B 27/32; B32B 27/08; B32B 7/12; B32B 1/00; B32B 2307/31; B32B 2307/516; B32B 2307/518; B32B 2439/46; B32B 2250/03; B32B 2250/242; B32B 37/153

(57) ABSTRACT

A plastic film composite for film packaging has a first surface and a second surface, a monoaxially oriented polyethylene film and a sealing layer at the second surface. The plastic film composite also comprises a biaxially oriented polyethylene film.

The invention is directed to a plastic film composite for film packaging with a first surface and a second surface, a monoaxially oriented polyethylene film and a sealing layer at the second surface. The subject matter of the invention is further a film packaging formed from the plastic film composite and a method for producing the plastic film composite.

Various plastic film packaging composites are known from practice which have a layer sequence that is optimized with respect to the production of the film packaging and the visual appearance of the film packaging.

As is also described in EP 2 186 741 B1, polyethylene terephthalate (PET) is frequently employed for the outer film and polyethylene is used for a sealing film provided as inner film in order to achieve a good heat-sealability and a high-quality visual appearance of a film packaging bag. However, this construction which is common in practice has the disadvantage that a single-stream recycling of the gusseted bag is not possible.

A gusseted bag which is formed substantially homogeneously from polyethylene and a method for production are known from EP 2 987 744 B1. In generic plastic film composites according to a preferred configuration, a monoaxially oriented outer film and a sealing film are first produced separately and then glued by means of a polyurethane-based two-component adhesive.

Films of monoaxially oriented polyethylene and particularly high-density monoaxially oriented polyethylene are characterized by a relatively high stiffness, good optical characteristics and also by a high tensile strength at least in direction of orientation.

Due to the monoaxial orientation, however, the mechanical characteristics are highly anisotropic. There is a comparatively low tensile strength especially transverse to the orientation direction, for which reason monoaxially oriented films generally have a linear crack propagation along the orientation direction and, overall, have only a poor puncture resistance and flex resistance. Especially when there is a crease running along the orientation direction, there is an increased risk of tearing or rupture, and a tear of this kind can also easily propagate along the orientation direction.

The anisotropic mechanical behavior of monoaxially oriented polyethylene films is known. For example, tape fabrics are formed from film strips oriented along their longitudinal direction, and high strengths can be generated on the whole through the intersecting arrangement in the woven fabric.

It is also possible, in principle, to laminate two monoaxially oriented polyethylene films with an orientation direction arranged perpendicular to one another. A corresponding multilayer polyethylene film for producing flexible packaging receptacles is known from DE 92 10 530 U1. For production, a polyethylene-based blown film is first extruded and cooled before carrying out a drawing of the film tube below the crystalline melting point for orientation. This results in a thinning of the film tube accompanied by axial stretching of the molecular chains. The film tube is then cut up helically. This results in a flat web with a monoaxial orientation running diagonally with respect to the longitudinal direction of the flat web. Two flat webs oriented with a 90-degree offset are then connected, that is, laminated, to one another to form a plastic film composite. The described method is relatively expensive overall. Also, the design possibilities with respect to plastic packaging to be formed are limited because there are always two identically arranged plies of monoaxially oriented polyethylene film.

In view of the foregoing, it is the object of the present invention to provide a high-quality, easily recyclable plastic film composite for film packaging which is also adaptable with respect to its construction. Further, corresponding plastic packaging, particularly a plastic packaging bag, and a method for producing the plastic film composite are also to be provided.

This object is met by the subject matter of the invention which is a plastic film composite according to patent claim 1, plastic packaging according to patent claim 10 and a method for producing a plastic composite according to patent claim 11.

Proceeding from a generic plastic film composite for film packaging with a first surface and a second surface, a monoaxially oriented polyethylene film and a sealing layer at the second surface, a biaxially oriented polyethylene film is provided according to the invention.

Surprisingly, by incorporating a biaxially oriented polyethylene film in the plastic film composite the tear resistance, flex resistance and puncture resistance can be very sharply increased even when the biaxially oriented polyethylene film is formed comparatively thin and accordingly contributes little to the total thickness of the plastic film composite.

In particular, the stabilizing effect of the biaxially oriented polyethylene film is much greater than the stabilizing effect of an unoriented polyethylene film of equal or even considerably greater thickness. In biaxially oriented film, the individual molecular chains have no clear preferential direction and are also aligned in different directions of the film plane as with an unoriented film. As a result of the orientation, however, the individual polymer strands are less tangled and more like elongated strands so that a relatively high tensile strength is achieved overall in any directions in the plane of the biaxially oriented polyethylene film. Also, as a result, no particular alignment or arrangement of the biaxially oriented polyethylene film need be observed in the production of the plastic film composite.

It can be assumed that the particularly advantageous stabilizing effect of the biaxially oriented polyethylene film can also be attributed essentially to the high tensile strength.

According to a preferred configuration, the monoaxially oriented polyethylene film forms the first surface which, in the case of film packaging, then also forms the outer side of the packaging. The monoaxially oriented polyethylene film is characterized by good optical properties and minimal surface roughness.

Regardless of the specific arrangement of the monoaxially oriented polyethylene film, the thickness typically amounts to 10 μm and 70 μm, preferably between 20 μm and 50 μm.

As has already been mentioned, the biaxially oriented polyethylene film can also be formed appreciably thinner in comparison with the monoaxially oriented polyethylene film but with a considerable improvement in the puncture resistance and flex crack resistance of the entire plastic film composite. The thickness of the biaxially oriented polyethylene film can be between 10 μm and 40 μm, preferably between 15 μm and 30 μm, for example.

According to a particularly preferred configuration of the invention, it is provided that the monoaxially oriented polyethylene film has a greater thickness than the biaxially oriented polyethylene film, and the thickness ratio preferably amounts to at least 3:2, particularly preferably at least 2:1. The specified thickness ratios of at least 3:2 and preferably 2:1 can be provided particularly when the biaxially oriented polyethylene film is extruded in one layer as monofilm in a particularly simple manner according to a preferred configuration of the invention. The specified ratios can also be achieved with a multilayer coextrusion of the biaxially oriented polyethylene film which will be explained in more detail in the following. In a particularly preferred manner, the thickness ratio in a multilayer coextruded biaxially oriented polyethylene film is adjusted to a range between 2:1 and 1:2.

The plastic film composite according to the invention comprises at least the monoaxially oriented polyethylene film and the biaxially oriented polyethylene film which can be connected to one another, for example, by adhesive or an extrusion lamination.

Accordingly, two films are extruded separately from one another and subsequently monoaxially and biaxially oriented, respectively, before the plastic film composite is formed. In this respect, it is possible that the sealing layer at the second surface is formed by the biaxially oriented polyethylene film which can also be configured to be favorably sealable in spite of the biaxial orientation through a corresponding formulation of the constituents.

When the sealing layer at the second surface is formed by the biaxially oriented polyethylene film according to the above-described variant of the invention, this biaxially oriented polyethylene film is particularly preferably coextruded in order to furnish the sealing layer with particularly good sealing characteristics with respect to fusibility, bonding strength and other sealing parameters. Apart from suitable additions, types of polyethylene which are particularly favorably sealable in spite of the biaxial orientation can also be selected. Suitable types are, for example, low-density polyethylene (LDPE), linear low-density polyethylene (LLDPE) and very low-density polyethylene (VLDPE). Types obtained by metallocene catalysts and polyethylene copolymers are also contemplated. With respect to very low-density polyethylene (VLDPE), types with plastomer properties typically having a density between 0.886 to 0.915 g/cm³ are particularly suitable. As regards the typical properties of polyethylenes and the association with various density ranges, reference is made particularly to “Saechtling Kunststoff Taschenbuch”, 31st edition, Carl Hanser Verlag, Munich 2013, pages 432ff.

According to the invention, the monoaxially oriented polyethylene film and the biaxially oriented polyethylene film are both formed on the basis of polyethylene. This means that a polyethylene, a polyethylene copolymer or a polyethylene blend forms the chief constituent of the respective film. However, it will be appreciated that conventional additions and fillers can be provided. According to a preferred configuration of the invention, all of the films forming the plastic film composite comprise at least 80 wt %, particularly preferably at least 90 wt % and, for example, at least 95 wt % of polyethylene.

According to a further aspect of the present invention, it is provided that the biaxially oriented polyethylene film is arranged between the monoaxially oriented polyethylene film and a separate sealing film forming the sealing layer. The sealing film is preferably formed as a single-layer or multilayer blown film and can typically have a thickness between 25 μm and 90 μm. As regards a configuration of this type, the biaxially oriented polyethylene film which is then provided as a kind of core layer is preferably formed as a single monofilm.

In order to achieve a high draw ratio in the monoaxially oriented polyethylene film and/or the biaxially oriented polyethylene film, the corresponding film is preferably formed by flat film extrusion. However, a blown film extrusion can also be contemplated in principle. With respect to a monoaxial orientation, a draw ratio between 1:8 and 1:12 can easily be achieved in a flat film, while a lower draw ratio, for example, between 1:3 and 1:8, is usually selected for blown films.

For purposes of a simple production, an orientation is provided particularly in machine direction. The cool or, in any case, warm film is then guided over rollers driven at different speeds below the crystalline melting point and, accordingly, drawn in machine direction, i.e., the longitudinal direction of the material web. Provided that no slippage occurs, the draw ratio is given by the web speed at the surface of the respective rollers, and the orientation can easily be carried out in a plurality of steps.

Various methods for biaxial orientation are known. For example, a two-step biaxial drawing may be carried out in which drawing is carried out in longitudinal direction in one work step in the above-described manner by rollers rotating at different speeds and elongation in transverse direction is subsequently made possible by means of a suitable stretching frame. Known stretching frames have circulating chains which grasp the edges of the film and expand the film in a V-shaped manner in transverse direction.

Finally, a biaxial orientation can also be carried out by simultaneous drawing with a scissor grate system. The individual edge-side clamping points of the film are moved away from each other in transverse direction and in longitudinal direction. However, the steps described for monoaxial and biaxial orientation are merely exemplary.

Insofar as a separate sealing film is provided, this sealing film preferably does not have a monoaxial or biaxial orientation. In particular, simple blown films which can be economically produced by blown film extrusion are suitable.

As has already been mentioned, the films forming the plastic composite can be joined by adhesive and/or extrusion lamination. In particular, polyethylene-based adhesives which are available in solvent-free or solvent-containing form and as two-component systems are contemplated as adhesives.

In order to achieve an increased bonding strength, an at least one-layer extrusion lamination based on polyethylene can also be provided. The layer thickness of an extrusion lamination of this kind is typically greater than 5 μm, particularly preferably greater than 10 μm. In particular, the layer thickness can amount to between 12 μm and 28 μm. As regards the adjoining films, a two-layer extrusion lamination may also be advisable in order to achieve an optimal bonding to the respective adjoining film or adjoining layer.

Surprisingly, the bearing strength of the plastic film composite at sealing seams can also be increased by an extrusion lamination of this kind to prevent uncontrolled bursting or tearing.

The total thickness of the plastic film composite is typically between 40 μm and 200 μm, particularly preferably between 60 μm and 140 μm.

Accordingly, the plastic film composite can be formed from exactly three preproduced films if a separate sealing film is provided. Otherwise, the plastic film composite is preferably formed from exactly two preproduced films, namely, the monoaxially oriented polyethylene film and the biaxially oriented polyethylene film.

Depending on the purpose of use, it must be taken into consideration that polyethylene-based films and accordingly also the monoaxially oriented polyethylene film and the biaxially oriented polyethylene film have a good barrier effect against water vapor. On the other hand, the barrier effect against acid and aromatic compounds is relatively poor so that an additional barrier is advisable for many applications. To this end, a barrier coating can be provided on one of the films of the plastic film composite and particularly preferably on the biaxially oriented polyethylene film. A PVOH coating, a SiOx evaporation or a metallization are suitable. Corresponding layers are very thin so that there is generally very little impediment to recycling.

Further, thin barrier layers can also be introduced in the plastic film composite. For example, when a separate sealing film is provided, this separate sealing film can also have, in case of a multilayer coextrusion, a layer, particularly a core layer, comprising a barrier material, for example, EVOH. Appropriate blown films can have in particular (preferably symmetrically) five layers, in which case the barrier layer is provided as central core layer. In this respect, it is advisable to form the barrier layer very thin with a thickness of 1 to 5 μm, for example. In particular, the ethylene vinyl alcohol copolymer (EVOH or EVHL) which has already been mentioned as preferred may be formed with a small layer thickness of this kind. Further, this is a matter of an ethylene copolymer with an ethylene percentage of typically 62% to 73%. For this reason also, small amounts of EVOH in a recyclate can be accepted in many cases.

The subject matter of the invention is also plastic packaging, particularly a plastic bag, with a bag body formed from the above-described plastic film composite. For example, the bag body can be formed from a portion of the plastic film composite or from a plurality of portions of the plastic film composite by folding and sealing.

If only two blanks of the plastic film composite are joined at the edge to form a cushioned-shaped bag, folding is not necessary. Regardless of the specific shape of the bag body, however, at least one seal, particularly at least one heat-sealing seam, is always provided, for which reason the plastic film composite has the sealing layer at the second surface.

In addition to the above-described simple cushion shape, the bag body can also be constructed as an upright bag, a gusseted bag, or the like.

Lastly, the plastic bag can also have other features such as a spout, reclosure and a partial handle. Especially with additional features of this kind, locally increased forces can act on the bag body so that the stabilization achieved according to the invention by means of the combination of monoaxially oriented polyethylene film with biaxially oriented polyethylene film is also particularly advantageous.

Owing to the high puncture resistance and flex crack resistance, the plastic packaging is also suitable for liquid fill goods, heavy fill goods and, to some extent, sharp-edged fill goods. For example, various liquids such as liquid detergents, beverages, dishwashing liquids, household chemicals, liquid foodstuffs and the like are contemplated as fill goods. Apart from various solid and/or granular foodstuffs, powdered detergent, detergent tablets and the like may also be provided as fill goods. Lastly, substantially child-proof packaging for medications or other hazardous substances can also be achieved owing to the high puncture resistance and flex crack resistance.

Finally, the subject matter of the invention is also a method for producing a plastic film composite, wherein a first polyethylene film is extruded particularly as flat film and is monoaxially oriented in a subsequent method step, wherein a second polyethylene film is extruded particularly as flat film and is biaxially oriented in a subsequent method step, and wherein the monoaxially oriented polyethylene film and the biaxially oriented polyethylene film are laminated together possibly with further preproduced films.

According to a further development of the method according to the invention, a third polyethylene film is extruded, particularly as blown film, and is not provided with an orientation. During the lamination, the biaxially oriented polyethylene film is then arranged between the monoaxially oriented polyethylene film and the third polyethylene film provided as sealing film.

The preceding statements regarding the plastic film composite itself are referred to with regard to the further features of the plastic packaging according to the invention and the method according to the invention for producing the plastic film composite.

The invention will be described in the following referring to figures. The figures show:

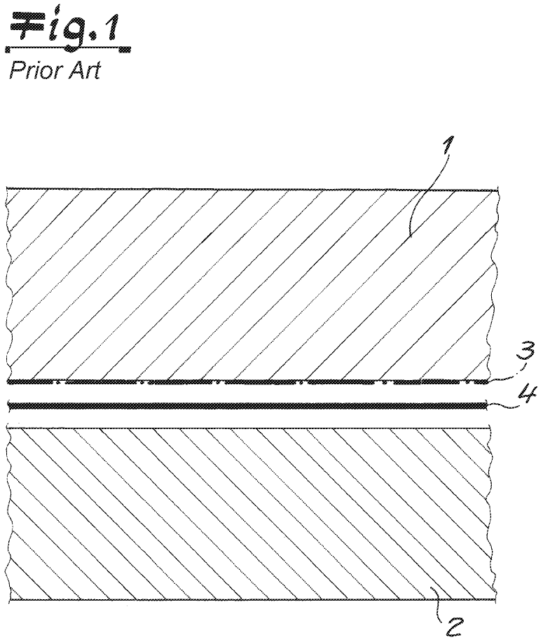

FIG. 1 a plastic film composite according to the prior art;

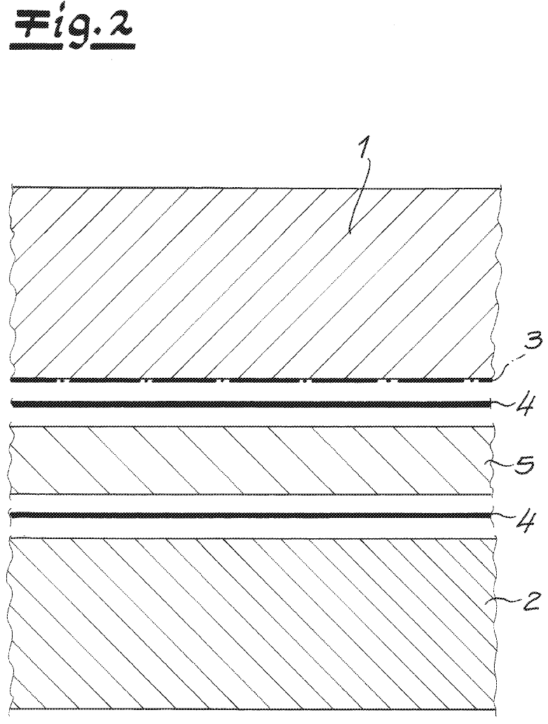

FIG. 2 a plastic film composite according to the invention;

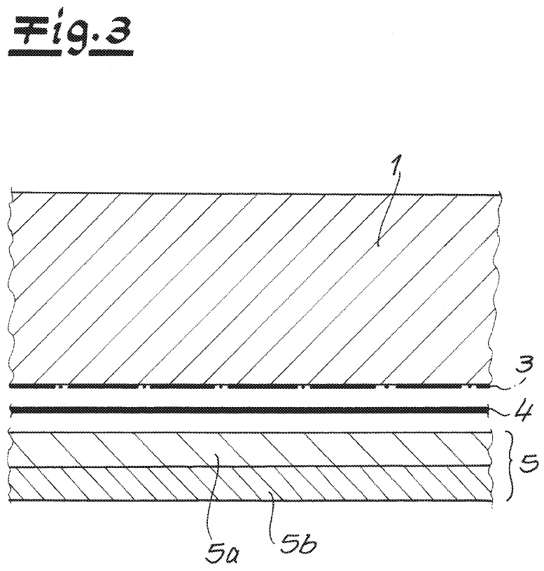

FIG. 3 an alternative configuration of the plastic film composite according to the invention.

FIG. 1 shows a plastic film composite according to the prior art. The plastic film composite has a monoaxially oriented polyethylene film 1 which forms a first surface of the plastic film composite. A sealing layer of a polyethylene-based sealing film 2 is formed at an opposite second surface of the plastic film composite.

While the first surface with the monoaxially oriented polyethylene film 1 arranged on it usually forms the outer side in plastic packaging, the second surface forming the sealing film 2 at an inner side of the film packaging faces an interior of the packaging. It is possible for the sealing film to form a bag body by means of heat-sealing seams.

Without limiting generality, the sealing film may comprise one or more layers. For the sake of simplicity, only the sealing film 2 as a whole is shown without any specific layer sequence.

The monoaxially oriented polyethylene film 1 is characterized by a high-quality appearance and is provided at its side facing the sealing film with printing 3 which is protected from rubbing off owing to its arrangement on the inner side (reverse printing). In principle, it can also be contemplated to arrange the printing on the first surface of the plastic film composite (front-side printing).

According to FIG. 1, the monoaxially oriented polyethylene film 1 and the sealing film 2 which is preferably formed as blown film are laminated together directly. A polyurethane adhesive, for example, is contemplated for this purpose. In the depicted embodiment example, the thickness of the monoaxially oriented polyethylene film 1 is 50 μm, for example, and the thickness of the sealing film 2 is 45 μm, for example. Typical area densities are 3 g/m² for the print 3, for example, and 2 g/m² for the adhesive 4.

Plastic packaging formed from the plastic film composite according to the prior art has only a limited mechanical bearing strength and, in particular, a low puncture resistance and a low flex crack resistance.

FIG. 2 shows a possible configuration of a plastic film composite according to the invention in which a biaxially oriented polyethylene film 5 is arranged as further preproduced film between the monoaxially oriented polyethylene film 1 and the sealing film 2. Correspondingly, in a configuration that matches in other respects, a further layer of adhesive 4 is necessary. In the depicted embodiment example, the thickness of the biaxially oriented polyethylene film 5 is 18 μm, for example.

Although the biaxially oriented polyethylene film is therefore comparatively thin, there is a considerable improvement in the puncture resistance and flex crack resistance of the entire plastic film composite. In the configuration shown in FIG. 2, the biaxially oriented polyethylene film 5 is preferably formed as a monofilm, but multilayer configurations are also contemplated in principle.

Finally, FIG. 3 shows a further variant of the plastic film composite according to the invention for film packaging, wherein the monoaxially oriented polyethylene film 1 is arranged and configured as before. However, a separate sealing film 2 is dispensed with so that the plastic film composite is formed only from the preproduced monoaxially oriented polyethylene film 1 and the preproduced biaxially oriented polyethylene film 5 with the printing 3 and adhesive 4 arranged therebetween.

In order to achieve a good heat-sealability, the biaxially oriented polyethylene film 5 can be formed of multiple layers. In the two-layer configuration shown by way of example, one layer 5a of the biaxially oriented polyethylene film 5 contacts the adhesive 4, while a further layer 5b of the biaxially oriented polyethylene film 5 forms the sealing layer.

The two-layer configuration which is depicted solely by way of example is meant to illustrate that an optimization and also a certain functional separation can be achieved in the biaxially oriented polyethylene film 5 by dividing into a plurality of layers 5a, 5b. Contrary to the merely exemplary two-layer configuration, biaxially oriented polyethylene films having at least three layers and formed in particular by coextrusion are suitable in practice. In particular, with regard to the biaxially oriented polyethylene film 5 as well as the plastic film composite formed as a whole, a symmetrical layer construction with an odd quantity of layers can be selected so that unwanted stresses and curl can be avoided.

Also in the configuration depicted in FIG. 3, the biaxially oriented polyethylene film 5 can have a thickness of 18 μm, for example. Accordingly, compared to the construction according to the prior art in FIG. 1, an appreciably smaller thickness of the plastic film composite in its entirety results as a whole, but the puncture resistance and the flex crack resistance are nevertheless greatly increased.

The configurations shown in FIGS. 2 and 3 are merely exemplary, and it will be appreciated that further modifications and alternatives are also possible. For example, it can be provided that polyethylene is fusibly extruded on the biaxially oriented polyethylene film 5 to generate the sealing layer. Such an extrusion coating with polyethylene can be carried out in principle before or after the lamination of the biaxially oriented polyethylene film 5 with the monoaxially oriented polyethylene film 1. When the sealing layer is formed in the manner described above by a ply of extruded polyethylene, the biaxially oriented polyethylene film 5 can preferably be formed as a single-layer monofilm (see FIG. 2).

In an orienting trial, the puncture resistance in conformity to ASTM 3420-08a of the plastic film composites according to FIG. 1 and according to FIG. 3 are compared. The puncture resistance of the second surface in direction of the first surface was tested. In the plastic film composite according to FIG. 1, a puncture resistance of 12.6 newtons (N) resulted in the course of the orienting trial, while the puncture resistance for the plastic film composite according to FIG. 3 was outside of the predefined measurement range of up to 38 N (that is, greater).

Because of the surprisingly high puncture resistance, the plastic film composite according to the invention is also suitable for packaging applications in which increased security against unintentional opening is advisable because of pharmaceutical or other aggressive and/or toxically relevant contents. The plastic film composite is therefore also suitable for medications, solid or liquid household cleaners and other aggressive and/or poisonous chemicals. Packaging bags and blister packing can be formed, for example. The plastic film composite can also be used as cover foil in a receptacle formed in particular by deep drawing. In a receptacle of this kind, the cover often represents a potential weak point, for which reason greater strength and, in particular, enhanced puncture resistance are particularly advantageous especially in that area.

1. A plastic film composite for film packaging with a first surface and a second surface and a sealing layer at the second surface, wherein the film composite comprises a monoaxially oriented polyethylene film (1) and and a biaxially oriented polyethylene film (5), and wherein the monoaxially oriented polyethylene film (1) has a greater thickness than the biaxially oriented polyethylene film (5).

2. The plastic film composite according to claim 1, wherein the monoaxially oriented polyethylene film (1) forms the first surface.

3. The plastic film composite according to claim 1, wherein a thickness ratio between the monoaxially oriented polyethylene film and the biaxially oriented polyethylene film amounts to at least 3:2.

4. The plastic film composite according to claim 1, characterized in that wherein the thickness of the monoaxially oriented polyethylene film (1) amounts to between 10 μm and 70 μm.

5. The plastic film composite according to claim 1, wherein the thickness of the biaxially oriented polyethylene film (5) amounts to between 10 μm and 40 μm.

6. The plastic film composite according to claim 1, wherein the sealing layer at the second surface is formed by the biaxially oriented polyethylene film (5).

7. The plastic film composite according to claim 1, wherein the biaxially oriented polyethylene film (5) is arranged between the monoaxially oriented polyethylene film (1) and a separate sealing film (2) forming the sealing layer.

8. The plastic film composite according to claim 1, wherein the monoaxially oriented polyethylene film (1) or the biaxially oriented polyethylene film (5) is formed by flat film extrusion.

9. The plastic film composite according to claim 1, wherein the films forming the plastic film composite are joined by adhesive (4) or extrusion lamination.

10. A plastic packaging, particularly a plastic packaging bag, with a bag body formed from a plastic composite according to claim 1, wherein the first surface of the plastic film composite forms an outer side, and the second surface of the plastic film composite forms an inner side facing a packaging interior.

11. A method for producing a plastic film composite according to claim 1,
a) wherein a first polyethylene film is extruded as a flat film and is monoaxially oriented in a subsequent method step,
b) wherein a second polyethylene film is extruded as a flat film and is biaxially oriented in a subsequent method step, and
c) wherein the monoaxially oriented polyethylene film (1) and the biaxially oriented polyethylene film (5) are laminated together.

12. The method according to claim 11, wherein a third polyethylene film is extruded, particularly as a blown film, and wherein, during the lamination, the biaxially oriented polyethylene film (5) is arranged between the monoaxially oriented polyethylene film (1) and the third polyethylene film provided as sealing film (2).

13. The method according to claim 11, wherein polyethylene is extruded on the biaxially oriented polyethylene film (5) for generating the sealing layer.
